(19) United States
(12) Patent Application Publication
(10) Pub. No.: US 2025/0074601 A1
(43) Pub. Date: Mar. 6, 2025

(54) LESS BLEED ENVIRONMENTAL CONTROL SYSTEM

(71) Applicant: Hamilton Sundstrand Corporation, Charlotte, NC (US)

(72) Inventor: Mark G. Vignali, Simsbury, CT (US)

(21) Appl. No.: 18/460,999

(22) Filed: Sep. 5, 2023

(51) Int. Cl. B64D 13/08

(52) U.S. Cl. CPC B64D 13/08; B64D 2013/0618; B64D 2013/0648

(57) ABSTRACT

An environmental control system of an aircraft has a plurality of inlets including a first inlet for receiving a first medium and a second inlet for receiving a second medium. A thermodynamic device includes a compressor and at least one turbine and is fluidly coupled to the second inlet. A ram air circuit has a plurality of heat exchangers including a first heat exchanger and a second heat exchanger and is fluidly coupled to both the first inlet and the thermodynamic device. In a first mode, an outlet of the thermodynamic device is fluidly connected to the ram air circuit downstream from both the first heat exchanger and the second heat exchanger. In a second mode, the outlet of the thermodynamic device is fluidly connected to an inlet of one of the plurality of heat exchangers.

### BACKGROUND

Exemplary embodiments pertain to the art of environmental control systems, and more particularly, to an environmental control system of an aircraft.

In general, contemporary air condition systems are supplied a pressure at cruise that is approximately 30 psig to 35 psig. The trend in the aerospace industry today is towards systems with higher efficiency. One approach to improve airplane efficiency is to eliminate the bleed air entirely and use electrical power to compress outside air. A second approach is to use lower engine pressure. The third approach is to use the energy in the bleed air to compress outside air and bring it into the cabin. Unfortunately, each of these approaches provides limited efficiency with respect to engine fuel burn.

### SUMMARY

According to an embodiment, an environmental control system of an aircraft has a plurality of inlets including a first inlet for receiving a first medium and a second inlet for receiving a second medium. A thermodynamic device includes a compressor and at least one turbine and is fluidly coupled to the second inlet. A ram air circuit has a plurality of heat exchangers including a first heat exchanger and a second heat exchanger and is fluidly coupled to both the first inlet and the thermodynamic device. In a first mode, an outlet of the thermodynamic device is fluidly connected to the ram air circuit downstream from both the first heat exchanger and the second heat exchanger. In a second mode, the outlet of the thermodynamic device is fluidly connected to an inlet of one of the plurality of heat exchangers.

In addition to one or more of the features described above, or as an alternative to any of the foregoing embodiments in the first mode, the second medium is operable to draw a flow of ram air through the ram air circuit.

In addition to one or more of the features described above, or as an alternative to any of the foregoing embodiments in the first mode, only a conditioned first medium is provided to an outlet of the environmental control system.

In addition to one or more of the features described above, or as an alternative to any of the foregoing embodiments in the second mode, a conditioned form of both the first medium and the second medium is provided to the outlet of the environmental control system.

In addition to one or more of the features described above, or as an alternative to any of the foregoing embodiments in the first mode, the first inlet is fluidly connected to an inlet of both the first heat exchanger and the second heat exchanger.

In addition to one or more of the features described above, or as an alternative to any of the foregoing embodiments in the first mode, the first medium output from the first heat exchanger is mixed with the first medium output from the second heat exchanger.

In addition to one or more of the features described above, or as an alternative to any of the foregoing embodiments in the second mode, the first inlet is fluidly connected to only the inlet of the second heat exchanger.

In addition to one or more of the features described above, or as an alternative to any of the foregoing embodiments the second medium is provided to the ram air circuit from the outlet of the thermodynamic device.

In addition to one or more of the features described above, or as an alternative to any of the foregoing embodiments the outlet of the thermodynamic device is the outlet of the compressor.

In addition to one or more of the features described above, or as an alternative to any of the foregoing embodiments the at least one turbine of the thermodynamic device includes a first turbine and a second turbine.

In addition to one or more of the features described above, or as an alternative to any of the foregoing embodiments the first turbine is fluidly connected to the second heat exchanger.

In addition to one or more of the features described above, or as an alternative to any of the foregoing embodiments the plurality of inlets includes a third inlet configured to receive a third medium and the third turbine is fluidly coupled to the third inlet.

In addition to one or more of the features described above, or as an alternative to any of the foregoing embodiments the first mode is associated with operation of the aircraft when on the ground.

In addition to one or more of the features described above, or as an alternative to any of the foregoing embodiments the second mode is associated with operation of the aircraft at altitude.

In addition to one or more of the features described above, or as an alternative to any of the foregoing embodiments the first medium is bleed air and the second medium is outside air.

According to an embodiment, a method of operating an environmental control system of an aircraft includes providing a first medium to at least one heat exchanger of a ram air circuit, extracting energy from the first medium to form an expanded first medium, delivering the expanded first medium to an outlet associated with one or more loads of the aircraft, and compressing a second medium at a compressor to form a compressed second medium. Energy extracted from the first medium is used to drive the compressor. In a first mode of operation, the method includes drawing a flow of ram air through the ram air circuit using the compressed second medium and in a second mode of operation, the method includes conditioning the compressed second medium to form a conditioned compressed second medium for delivery to the outlet.

In addition to one or more of the features described above, or as an alternative to any of the foregoing embodiments in the first mode of operation, the first medium is provided to a first heat exchanger and a second heat exchanger of the ram air circuit.

In addition to one or more of the features described above, or as an alternative to any of the foregoing embodiments in the first mode of operation, the first medium is provided to the first heat exchanger and the second heat exchanger in parallel.

In addition to one or more of the features described above, or as an alternative to any of the foregoing embodiments in the second mode of operation, the first medium is provided to only the second heat exchanger of the ram air circuit.

In addition to one or more of the features described above, or as an alternative to any of the foregoing embodiments in the second mode of operation, further comprising extracting energy from a third medium. The energy extracted from the third medium is used to drive the compressor.

### BRIEF DESCRIPTION OF THE DRAWINGS

The following descriptions should not be considered limiting in any way. With reference to the accompanying drawings, like elements are numbered alike:

FIG. 1 is a schematic diagram of an environmental control system according to an embodiment;

FIG. 2 is a schematic diagram of the environmental control system of FIG. 1 in a first mode of operation according to an embodiment; and

FIG. 3 is a schematic diagram of the environmental control system of FIG. 1 in a second mode of operation according to another embodiment.

### DETAILED DESCRIPTION

A detailed description of one or more embodiments of the disclosed apparatus and method are presented herein by way of exemplification and not limitation with reference to the Figures.

Embodiments herein provide an environmental control system of an aircraft that uses mediums from different sources to power the environmental control system and to provide cabin pressurization and cooling at a high fuel burn efficiency. The medium can generally be air, while other examples include gases, liquids, fluidized solids, or slurries.

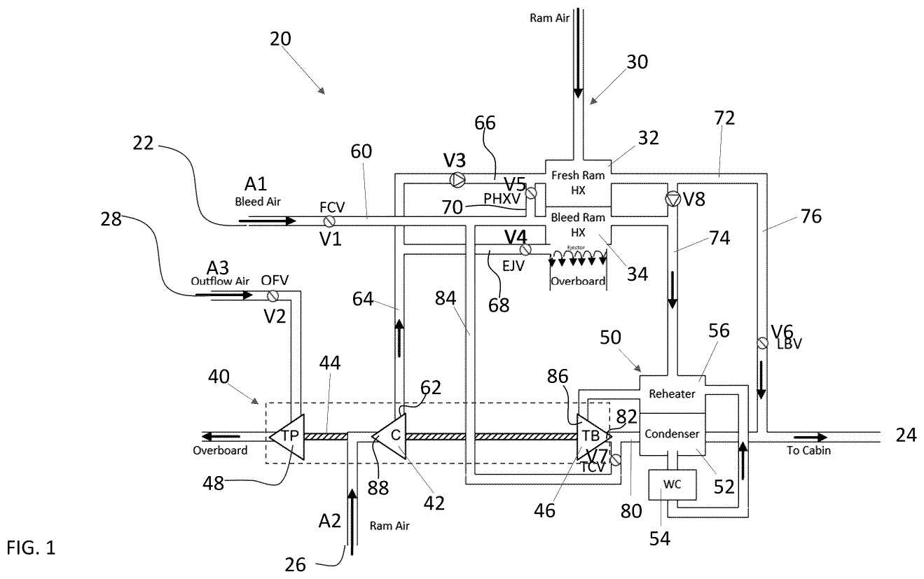

With reference now to the FIG. 1, a schematic diagram of a portion of an environment control system (ECS) 20, such as an air conditioning unit or pack for example, is depicted according to non-limiting embodiments. Although the environmental control system 20 is described with reference to an aircraft, alternative applications, such as another vehicle for example, are also within the scope of the disclosure. As shown in the figures, the system 20 can receive a first medium A1 at a first inlet 22. The first inlet may be operably coupled to a volume 24, such as the cabin of an aircraft via an outlet. As will be described herein in more detail, a conditioned first medium A1 may be provided to the volume 24 during normal operation. In embodiments where the environmental control system 20 is used in an aircraft application, the first medium A1 is bleed air, which is pressurized air originating from, i.e., being “bled” from, an engine or auxiliary power unit of the aircraft. It shall be understood that one or more of the temperature, humidity, and pressure of the bleed air can vary based upon the compressor stage and revolutions per minute of the engine or auxiliary power unit from which the air is drawn.

The system 20 is also configured to receive a second medium A2 at a second inlet 26. In an embodiment, the second medium A2 is fresh air, such as outside air for example. The outside air can be procured via one or more scooping mechanisms, such as an impact scoop or a flush scoop for example. Thus, the second inlet 26 can be considered a fresh or outside air inlet. In an embodiment, the second medium A2 is ram air drawn from a portion of a ram air circuit to be described in more detail below. Generally, the second medium A2 described herein is at an ambient pressure equal to an air pressure outside of the aircraft when the aircraft is on the ground and is between an ambient pressure and a cabin pressure when the aircraft is in flight. A conditioned form of the second medium A2 may be provided to the volume 24 during one or more modes of operation of the system 20.

The system 20 can further receive a third medium A3 at a third inlet 28. In one embodiment, the third medium A3 is cabin discharge or outflow air, which is air leaving the volume and that would typically be discharged overboard. In some embodiments, the system 20 is configured to extract work from the third medium A3. In this manner, the pressurized air A3 of the volume 24 can be utilized by the system 20 to achieve certain operations.

As shown, the environmental control system 20 may include a ram air circuit 30 including at least one heat exchanger. The ram air circuit 30 can receive and direct a medium, such as ram air for example, through a portion of the system 20. The one or more heat exchangers are devices built for efficient heat transfer from one medium to another. Examples of the type of heat exchangers that may be used, include, but are not limited to, double pipe, shell and tube, plate, plate and shell, adiabatic shell, plate fin, pillow plate, and fluid heat exchangers.

The one or more heat exchangers of the ram air circuit 30 may be referred to as ram heat exchangers. In the illustrated, non-limiting embodiment, the ram heat exchangers include a first or primary heat exchanger 32 and a second or secondary heat exchanger 34. Within the heat exchangers 32, 34, ram air, such as outside air for example, acts as a heat sink to cool a medium passing there through, for example the first medium A1 and/or the second medium A2. Although a ram air circuit 30 having only two heat exchangers 32, 34 is illustrated, it should be understood that embodiments having only a single heat exchanger, or alternatively, more than two heat exchangers are also contemplated herein.

The system 20 additionally includes at least one thermodynamic device 40, and in some embodiments includes a plurality of compression devices. Each thermodynamic device 40 is a mechanical device that includes components for performing thermodynamic work on a medium (e.g., extracts work from or applies work to the first medium A1, the second medium A2 by raising and/or lowering pressure and by raising and/or lowering temperature). Examples of a thermodynamic device 40 include an air cycle machine, a two-wheel air cycle machine, a three-wheel air cycle machine, a four-wheel air cycle machine, etc.

In the illustrated, non-limiting embodiment, the thermodynamic device 40 may include a compressor 42 and at least one turbine operably coupled by a shaft 44. A compressor 42 is a mechanical device configured to raise a pressure of a medium and can be driven by another mechanical device (e.g., a motor or a medium via a turbine). Examples of compressor types include centrifugal, diagonal or mixed-flow, axial-flow, reciprocating, ionic liquid piston, rotary screw, rotary vane, scroll, diaphragm, air bubble, etc. In an embodiment, the thermodynamic device 40 includes two turbines 46, 48. A turbine, such as either turbines 46, 48 for example, is a mechanical device that expand a medium and extract work therefrom (also referred to as extracting energy) to drive the compressor 42 via the shaft 44.

The system 20 additionally includes a dehumidification system 50. In the illustrated, non-limiting embodiment, the dehumidification system 50 includes a condenser 52 and a water extractor 54 arranged downstream from the condenser 52. The condenser 52 and the water extractor 54 are arranged in fluid communication with the first medium A1, and in some embodiments, with both the first medium A1 and the second medium A2. The condenser 52 is a particular type of heat exchanger and the water collector 54 is a mechanical device that performs a process of removing water from a medium. In some embodiments, the dehumidification system 50 includes a reheater 56. It should be appreciated that the dehumidification system illustrated and described herein is intended as an example only, and that embodiments where the dehumidifcation system has another configuration are also contemplated herein.

The elements of the system 20 are connected via valves, tubes, pipes, and the like. For example, the inlet 22 of the first medium may be fluidly connected to an inlet of the second heat exchanger 34 via a conduit 60. An outlet 62 of the compressor 42 is fluidly coupled to the ram air circuit 30 via a conduit 64. In an embodiment, the conduit 64 separates into a parallel first branch 66 and second branch 68. The first branch 66 may be connected to an inlet of the first heat exchanger 32 and the second branch 68 may be connected to the ram air circuit 30 at a location downstream from the plurality of ram air heat exchangers 32, 34. In an embodiment, a conduit 70 fluidly connects the first conduit 60 associated with the first medium A1 to the first branch 66 of conduit 64. The conduit 70 may be fluidly connected to both the conduit 60 and the first branch 66 at a location upstream from the inlets of both the first heat exchanger 32 and the second heat exchanger 34.

A conduit 72 extending from an outlet of the first heat exchanger 32 may split into a parallel primary conduit 74 and a bypass conduit 76. As shown, a conduit 78 extending from the outlet of the second heat exchanger 34 may be fluidly coupled to the primary conduit 74 such that a flow output from the second heat exchanger 34 mixes with the flow output from the first heat exchanger 32 within the primary conduit 74. The primary conduit 74 is connected to the dehumidification system 50, such as to an inlet of first pass of a reheater 56 for example. In an embodiment, there is only a single flow path extending through the dehumidification system 50. As a result, the flow output from the dehumidification system 50, such as from an outlet of a second pass of the reheater 56 for example, is provided to an inlet of the first turbine 46. A conduit 80 extending from the outlet 82 of the first turbine 46 may be connected to an inlet of a condenser 52 of the dehumidification system. In an embodiment, a second bypass conduit 84 extends between and fluidly connects the conduit 60 to and the conduit extending from the outlet of the first turbine 46. The second bypass conduit 84 is connected to the conduit 60 at a location upstream from the inlet of the second heat exchanger 32. A flow of medium provided to the second bypass conduit 84 is configured to bypass the ram air circuit 30, the first turbine 46, and the majority of the flow through the dehumidification system 50, thereby adding heat to the flow of medium provided to the volume 24 via the outlet.

Valves (e.g., flow regulation device or mass flow valve) are devices that regulate, direct, and/or control a flow of a medium by opening, closing, or partially obstructing various passageways within the tubes, pipes, etc. of the system. Valves can be operated by actuators, such that flow rates of the medium in any portion of the system 20 can be regulated to a desired value. For instance, a first valve V1 may be configured to control a supply of the first medium A1 to the system 20, and a second valve V2 may be configured to control a supply of the third medium A3 to the system 20. In an embodiment, a third valve V3 is operable to control a flow of the second medium to the first heat exchanger 32, and a fourth valve V4 is operable to control a flow of the second medium exhausted into the ram air circuit 30. A fifth valve V5 may be operable to control a flow within the between the conduit 70 fluidly coupling the conduit 60 and the first branch 66. A sixth valve V6 may be arranged within the bypass conduit 76 and is operable to allow a flow output from the first heat exchanger 32 to bypass the remainder of the system 20 including the dehumidification system 50 and the first turbine 46. Similarly, a seventh valve V7 may be operable to control a flow provided to the second bypass conduit 84 and an eight valve V8 may be configured to fluidly couple or isolate the outlets of the first and second heat exchangers 32, 34.

With continued reference to the system of FIGS. 1-3, the system 20 is operable in a plurality of modes, selectable based on a flight condition of the aircraft. For example, the system 20 may be operable in a first, low altitude mode or a second, high altitude mode. The first, low altitude mode is typically used for ground and low altitude flight conditions, such as ground idle, taxi, take-off, and hold conditions, and the second, high altitude mode may be used at high altitude cruise, climb, and descent flight conditions.

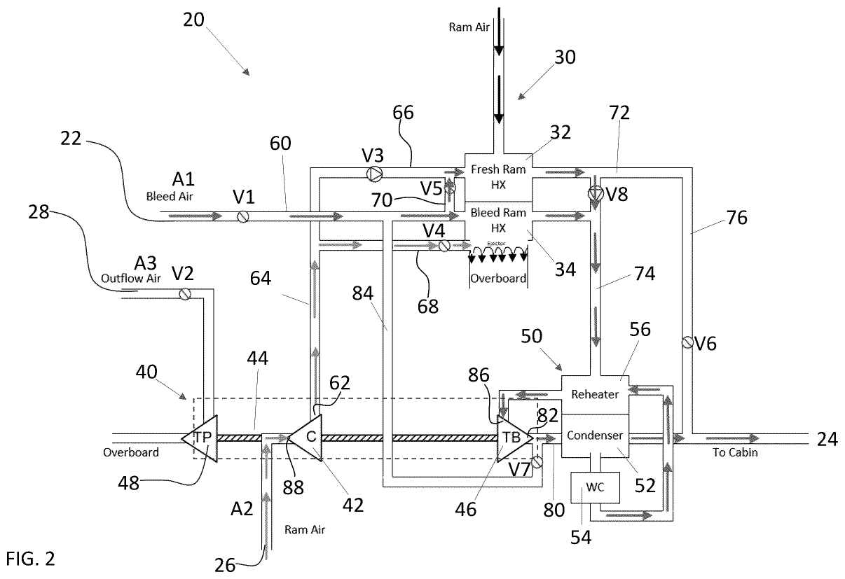

With reference to FIG. 2, during normal operation in the first, low altitude mode, valves V1, V4. V5, and V8 are open, and valves V2, V3, V6 and V7 are closed. As a result, a flow of high pressure first medium A1, such as bleed air drawn from an engine or APU, is provided to the system 20. Because valve V5 is open, the first conduit 60 is fluidly connected to both the first heat exchanger 32 and the second heat exchanger 34. Accordingly, a portion of the first medium A1 within the first conduit 60 is configured to pass through conduit 70 to the first branch 66 such that the first medium A1 is provided to both the first heat exchanger 32 and the second heat exchanger 34 in parallel. Within both the first heat exchanger 32 and the second heat exchanger 34, a flow of ram air acts as a heat sink, thereby cooling the first medium A1. However, because the second heat exchanger 34 is arranged downstream from the first heat exchanger 32 relative to the flow of ram air, the first medium A1 within the second heat exchanger 34 is cooled less than the first medium A1 within the first heat exchanger 32. Because valve V8 is open and valve V6 is closed, the first medium A1 output from both heat exchangers 32, 34 is directed toward the primary conduit 74 where the flows are mixed and provided to the dehumidification system 50.

The first medium A1 is configured to flow through a first pass of the reheater 56, the condenser 52, and the water extractor 54 sequentially. The first medium A1 is cooled and further cooled within the reheater 56 and the condenser 52, respectively, causing any moisture within the medium or mixed medium to condense. Moisture is then removed within the water extractor 54 and the first medium A1 is provided to a second pass of the reheater 56. Within this cold second pass of the reheater 56, the first medium A1 is partially heated to produce a warm, dry first medium A1. From the outlet of the reheater 56, the warm, dry first medium A1 is provided to an inlet 86 of the first turbine 46. The first medium A1 is expanded across the first turbine 46 and energy is extracted therefrom. The energy or work extracted by the first turbine 46 drives the compressor 42 via the shaft 44. The expanded first medium provided at the outlet of the turbine 44 is then provided to a second pass of the condenser 52, where the first medium A1 is heated prior to being delivered to one or more loads of the aircraft, such as the volume 24 for example.

At the same time, the second medium A2 is provided to an inlet 88 of a compressor 42 of the thermodynamic device 40. The act of compressing the second medium A2, heats the second medium A2 and increases the pressure of the second medium A2. Accordingly, the temperature and pressure of the compressed second medium A2 output from an outlet 62 of the compressor 42 is greater than the temperature and pressure of the second medium A2 provided to the inlet 88.

With the third valve V3 closed and the fourth valve V4 open, all of the compressed second medium A2 output from the compressor 42 is provided to the ram air circuit 30, such as at a location downstream from all of the plurality of heat exchangers within the ram air circuit 30. Accordingly, in the first mode, the compressor outlet 62 is only fluidly connected to the ram air circuit 30 at a location downstream from both the first and second heat exchangers 32, 34. Because of its pressure, the flow of the second medium A2 when provided to the ram air circuit 30 is configured to draw a flow of ram air into and through the circuit. Accordingly, the second medium A2 provided to ram air circuit 30 is similar to a motive flow of an ejector and the negative pressure generated by the flow of the second medium pulls the ram air across the plurality of heat exchangers 32, 34 before being mixed with the second medium A2. This mixture of second medium A2 and ram air may then be exhausted overboard.

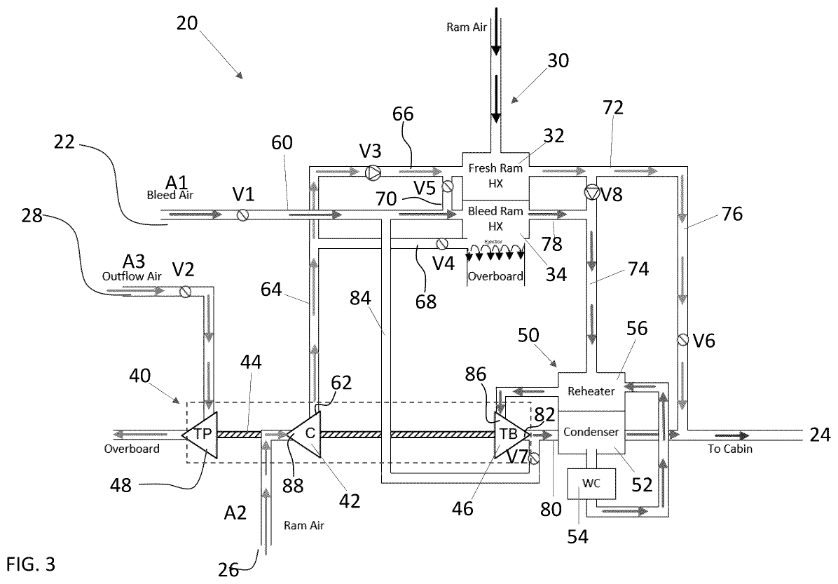

With reference now to FIG. 3, operation of the system 20 in a second, high-altitude mode is illustrated. During normal operation in the second mode, valves V1, V2, V3, and V6 are open, and valves V4, V5, V7, and V8 are closed. As a result, a flow of high pressure first medium A1, such as bleed air drawn from an engine or APU, is provided to the system 20. Because valve V5 is closed, the entire flow of first medium within the first conduit 60 is provided to the second heat exchanger 34. Said another way, in the second mode, the first conduit 60 is only fluidly connected to the inlet of the second heat exchanger 34. Within the second heat exchanger 34, a flow of ram air acts as a heat sink, thereby cooling the first medium A1. The cool first medium A1 output from the second heat exchanger 34 is then provided to the dehumidification system 50. During the second, mode of operation, the movement of the aircraft is sufficient to draw a flow of ram air through the ram air circuit. Accordingly, because the second medium A2 is operable to move ram air through the ram air circuit 30 in the first mode of operation and the movement of the aircraft itself is sufficient to move ram air through the ram air circuit 30 in the second mode of operation no fan need be associated with the ram air circuit. Accordingly, the thermodynamic device does not include a fan.

Within the dehumidification system 50, the first medium A1 is configured to flow through a first pass of the reheater 56, the condenser 52, and the water extractor 54 sequentially. The first medium A1 is cooled and further cooled within the reheater 56 and the condenser 52, respectively, causing any moisture within the medium or mixed medium to condense. Moisture is then removed within the water extractor 54 and the first medium A1 is provided to a second pass of the reheater 56. Within this cold second pass of the reheater 56, the first medium A1 is partially heated to produce a warm, dry first medium A1. From the outlet of the reheater 56, the warm, dry first medium A1 is provided to an inlet 86 of the turbine 46. The first medium A1 is expanded across the turbine 46 and work is extracted therefrom. The work extracted by the turbine 46 drives the compressor 42 via the shaft 44. The expanded first medium A1 provided at the outlet of the turbine 44 is then provided to a second pass of the condenser 52, where the first medium A1 is heated prior to being delivered to one or more loads of the aircraft, such as the volume 24 for example.

In the second mode of operation, the third medium A3 is provided to the second turbine 48. The third medium A3 is expanded across the second turbine 48 and work is extracted therefrom. The work extracted by the second turbine 48 drives the compressor 42 via the shaft 44. The expanded third medium A3 output from the second turbine 48 may be exhausted overboard or provided to another load of the aircraft.

At the same time, the second medium A2 is provided to an inlet 88 of a compressor 42 of the thermodynamic device 40. With the third valve V3 open and the fourth valve V4 closed, the entire flow of the compressed second medium A2 output from the compressor 42 is provided to the first heat exchanger 32. Within the first heat exchanger 32, a flow of ram air acts as a heat sink, thereby cooling the compressed second medium A2 to form a conditioned compressed second medium. It should be appreciated that in the illustrated, non-limiting embodiment, after cooling the second medium A2 within the first heat exchanger 32, the flow of ram air is provided to the second heat exchanger 34 to cool the flow of the first medium A1. Because the valve V8 is closed, and valve V6 is open the second medium output from the first heat exchanger 32 is provided to the bypass conduit 76. The second medium output from the bypass conduit is mixed with the first medium output from the condenser 52 at a location upstream from the one or more loads. Accordingly, in an embodiment, a mixture of both the first medium A1 and the second medium A2 is provided at the outlet of the system 20 to one or more loads.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. An environmental control system of an aircraft comprising:
a plurality of inlets including a first inlet for receiving a first medium and a second inlet for receiving a second medium;
a thermodynamic device including a compressor and at least one turbine, the thermodynamic device being fluidly coupled to the second inlet;
a ram air circuit having a plurality of heat exchangers including a first heat exchanger and a second heat exchanger, the ram air circuit being fluidly coupled to both the first inlet and the thermodynamic device; and
wherein the environmental control system is operable in a plurality of modes including a first mode and a second mode, in the first mode, an outlet of the thermodynamic device is fluidly connected to the ram air circuit downstream from both the first heat exchanger and the second heat exchanger and in the second mode, the outlet of the thermodynamic device is fluidly connected to an inlet of one of the plurality of heat exchangers.

2. The environmental control system of claim 1, wherein in the first mode, the second medium is operable to draw a flow of ram air through the ram air circuit.

3. The environmental control system of claim 1, wherein in the first mode, only a conditioned first medium is provided to an outlet of the environmental control system.

4. The environmental control system of claim 3, wherein in the second mode, a conditioned form of both the first medium and the second medium is provided to the outlet of the environmental control system.

5. The environmental control system of claim 1, wherein in the first mode, the first inlet is fluidly connected to an inlet of both the first heat exchanger and the second heat exchanger.

6. The environmental control system of claim 5, wherein in the first mode, the first medium output from the first heat exchanger is mixed with the first medium output from the second heat exchanger.

7. The environmental control system of claim 1, wherein in the second mode, the first inlet is fluidly connected to only the inlet of the second heat exchanger.

8. The environmental control system of claim 1, wherein the second medium is provided to the ram air circuit from the outlet of the thermodynamic device.

9. The environmental control system of claim 1, wherein the outlet of the thermodynamic device is the outlet of the compressor.

10. The environmental control system of claim 1, wherein the at least one turbine of the thermodynamic device includes a first turbine and a second turbine.

11. The environmental control system of claim 10, wherein the first turbine is fluidly connected to the second heat exchanger.

12. The environmental control system of claim 10, wherein the plurality of inlets includes a third inlet configured to receive a third medium and the third turbine is fluidly coupled to the third inlet.

13. The environmental control system of claim 1, wherein the first mode is associated with operation of the aircraft when on the ground.

14. The environmental control system of claim 1, wherein the second mode is associated with operation of the aircraft at altitude.

15. The environmental control system of claim 1, wherein the first medium is bleed air and the second medium is outside air.

16. A method of operating an environmental control system of an aircraft comprising:
providing a first medium to at least one heat exchanger of a ram air circuit;
extracting energy from the first medium to form an expanded first medium;
delivering the expanded first medium to an outlet associated with one or more loads of the aircraft;
compressing a second medium at a compressor to form a compressed second medium, wherein the energy extracted from the first medium is used to drive the compressor; and
in a first mode of operation drawing a flow of ram air through the ram air circuit using the compressed second medium and in a second mode of operation, conditioning the compressed second medium to form a conditioned compressed second medium deliverable to the outlet.

17. The method of claim 16, wherein in the first mode of operation, the first medium is provided to a first heat exchanger and a second heat exchanger of the ram air circuit.

18. The method of claim 17, wherein in the first mode of operation, the first medium is provided to the first heat exchanger and the second heat exchanger in parallel.

19. The method of claim 17, wherein in the second mode of operation, the first medium is provided to only the second heat exchanger of the ram air circuit.

20. The method of claim 16, wherein in the second mode of operation, further comprising extracting energy from a third medium, wherein the energy extracted from the third medium is used to drive the compressor.
